(19) United States
(12) Patent Application Publication
(10) Pub. No.: US 2005/0236779 A1
(43) Pub. Date: Oct. 27, 2005

(54) Dust-proof cover of transmission shaft

(76) Inventor: Bao Jie You, Feng yuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/829,290

(22) Filed: Apr. 22, 2004

(51) Int. Cl. F16J 15/52

(52) U.S. Cl. 277/636

(57) ABSTRACT

A dust-proof cover made of rubber comprises an elastic telescopic section including a plurality of axial enhancing ribs; a combining portion including a first combining section, a second combining section, and a third combining section; two buckling strips being included. An inner side of each of the second combining section and third combining section has a buckling strip; each buckling strip having a chamfered corner for guiding the installation of the transmission shaft unit so as to enhance the coupling of the dust-proof cover and the transmission shaft unit. Two buckling strips are formed on an inner surface of the first combining section; each buckling strip having a respective chamfered corner for buckling an outer lateral side of the transmission shaft unit so as to buckle the transmission shaft unit. A plurality of axial and radial texture are formed on the inner surface of the first combining section.

### FIELD OF THE INVENTION

The present invention relates to transmission shafts of vehicles, and particularly to a dust-proof cover of a transmission shaft, wherein the structure of the dust-proof cover can endure larger tension force. Moreover, The axial textures and radial textures on the inner surface of the first combining section have the effect of slide-proof.

### BACKGROUND OF THE INVENTION

In general, a dust-proof cover is used to cover a transmission shaft unit of a vehicle. The prior art dust-proof cover has a basic structure as illustrated in FIGS. 1A and 1B. The dust-proof cover has an elastic telescopic section L1 which is made of tuber and has a teethed outer side; and a combining portion L2 with a concave cambered surface 11. An inner wall of the combining portion L2 has a texture projection 13 and a buckling protrusion 12 which is formed with a plurality of sheets. The assembly of the dust-proof cover is illustrated in FIG. 1B. The combining portion L2 receives the periphery of the transmission shaft unit 1. The buckling protrusion 12 is engaged to an annular recess in the periphery of the transmission shaft unit 1 so that the transmission shaft unit 1 is firmly secured to the dust-proof cover 20. Moreover, the texture projection 13 can give a friction to the transmission shaft unit 1 so as to prevent the transmission shaft unit 1 from sliding out. However the prior art has the following disadvantages. The elastic telescopic section L1 is easily to break, especially in the folding V portions. Further, to make the transmission shaft unit 1 can be received firmly in the dust-proof cover, the elastic telescopic section L1 has a concave cambered surface 11 and the buckling protrusion 12 is formed with a plurality of sheets so that the transmission shaft unit 1 and the combining portion L2 can be combined easily and the transmission shaft unit 1 can receive in the combining portion L2.

The concave cambered surface 11 of the combining portion L2 is not wholly adhered to the outer surface of the transmission shaft unit 1 so that the transmission shaft unit 1 can be tightly positioned in the dust-proof cover. Moreover, the concave cambered surface 11 can not suffer from a great pull force from the transmission shaft unit 1 as the transmission shaft unit 1 moves and dusts are easily received in the concave cambered surface 11. The texture projection 13 can not prevent the transmission shaft unit 1 from rotation so that after a longer time period, the dust-proof cover will wear and as a result, the dust-proof cover can not be tightly combined with the transmission shaft unit 1. The width of the combining portion L2 is same as that of the elastic telescopic section L1. In combination, the combining portion L2 is expanded and thus it is thinned to reduce the tolerance thereof.

### SUMMARY OF THE INVENTION

Accordingly, the primary object of the present invention is to provide a dust-proof cover of a transmission shaft, wherein the structure of the dust-proof cover can endure larger tension force and thus the structure of the dust-proof cover of the present invention is firmly. Moreover, The axial textures and radial textures on the inner surface of the first combining section of the dust-proof cover have the effect of slide-proof.

To achieve above objects, the present invention provides a dust-proof cover which is made of rubber. The dust-proof cover comprises an elastic telescopic section including a plurality of axial enhancing ribs; a combining portion including a first combining section, a second combining section, and a third combining section; two buckling strips being included; an inner side of each of the second combining section and third combining section having a buckling strip; each buckling strip having a chamfered corner for guiding the installation of the transmission shaft unit so as to enhance the coupling of the dust-proof cover and the transmission shaft unit; two buckling strips being formed on an inner surface of the first combining section; each buckling strip having a respective chamfered corner for buckling an outer lateral side of the transmission shaft unit so as to buckle the transmission shaft unit; and a plurality of axial and radial textures being formed on the inner surface of the first combining section.

The various objects and advantages of the present invention will be more readily understood from the following detailed description when read in conjunction with the appended drawing.

### BRIEF DESCRIPTION OF THE DRAWINGS

FIG. 1 is a cross sectional view (A) and perspective view (B) of one prior art.

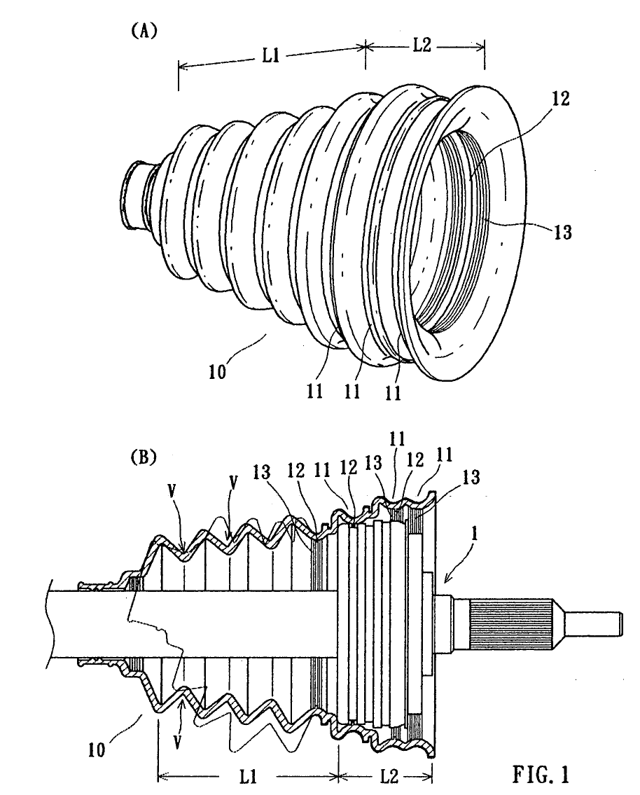

FIG. 2 is a perspective view of the present invention and a cross sectional view along a line A-A.

FIG. 3 is a cross sectional view and partial enlarged view of the present invention.

FIG. 4 is a schematic cross sectional view showing the use of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

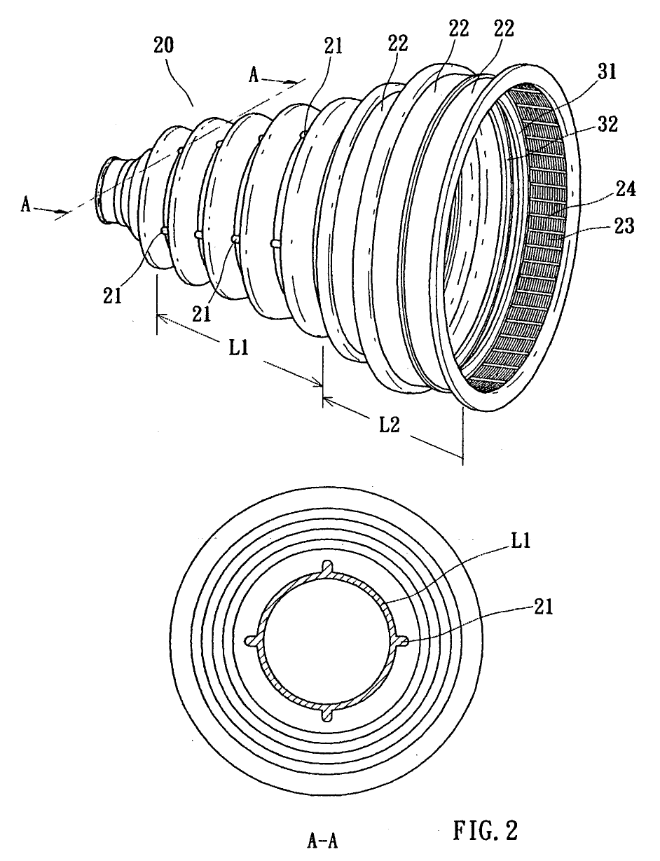

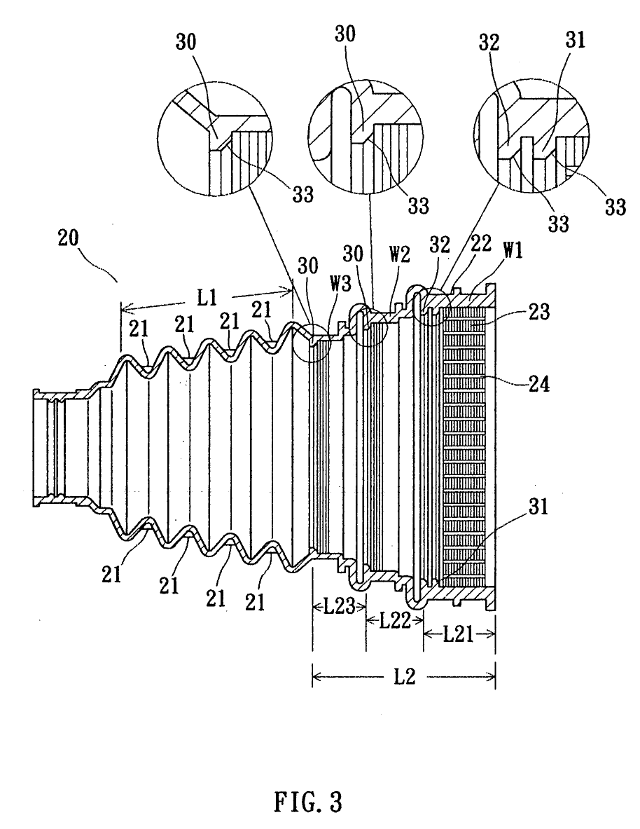

With reference to FIGS. 2, 3 and 4, the dust-proof cover of a transmission shaft of the present invention is illustrated. The dust-proof cover 20 made of rubber includes the following elements.

An elastic telescopic section L1 includes a plurality of axial enhancing ribs 21.

A combining portion L2 including a first combining section L21, a second combining section L22, and a third combining section L23. A width W1 of the first combining section L21 is greater than a width W2 of the second combining section L22 and the width W2 of the second combining section L22 is greater than the width W3 of the third combining section L23. An inner wall and an outer wall of each first combining section L21, second combining section L22 and third combining section L23 are planes 22.

Two buckling strips 30 are included. An inner side of each of the second combining section L22 and third combining section L23 has a buckling strip 30. Each buckling strip 30 has a chamfered corner 33 for guiding the installation of the transmission shaft unit 1 so as to enhance the coupling of the dust-proof cover and the transmission shaft unit 1.

Two buckling strips 31, 32 are formed on an inner surface of the first combining section L21. Each buckling strip 31, 32 has a respective chamfered corner 33 for buckling an outer lateral side of the transmission shaft unit 1 so as to buckle the transmission shaft unit 1.

A plurality of axial textures 23 are formed on the inner surface of the first combining section L21 and a plurality of radial textures 24 are formed on the inner surface of the first combining section L21.

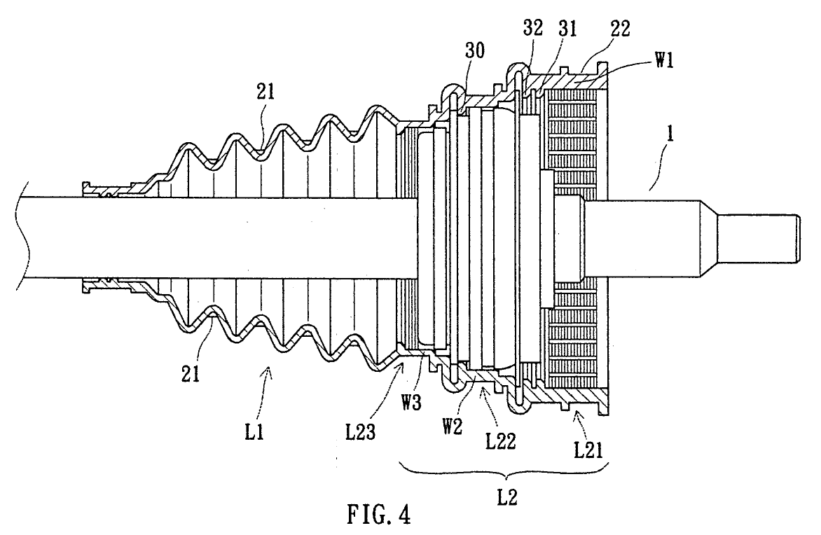

The present invention can be integrally formed by rubber. With reference to FIG. 4, in assembly, the combining portion L2 is combined with the transmission shaft unit 1.

With reference to FIG. 2, especially the section illustrated by line A-A, when the elastic telescopic section L1 is pulled, the enhancing ribs 21 on the elastic telescopic section L1 can suffer the tensional force expanding the elastic telescopic section L1 so as to prevent the elastic telescopic section L1 from breaking.

Since the width W1 of the first combining section L21 is greater than the width W2 of the second combining section L22 and the width W2 is greater than the width W3 of the third combining section L23 and generally, after combining with the transmission shaft unit 1, the sections nearer the first combining section L21 suffer from larger tension forces, the design of the widths W1, W2 and W3 cause that the structure of the dust-proof cover can endure larger tension forces and thus the structure of the dust-proof cover 20 of the present invention is firmly.

Furthermore, since the inner walls of the first combining section L21, second combining section L22 and third combining section L23 are planes, the area contacting the transmission shaft unit 1 is larger and thereby, the transmission shaft unit 1 is firmly positioned.

Moreover, in the present invention, each buckling strip 30, 31 and 32 has a chamber corner 33 so as to guide the transmission shaft unit 1 to be inserted into the dust-proof cover 20 easily. Furthermore, the buckling strips 31 and 32 have the effect of buckling the transmission shaft unit 1 as hooks so that the transmission shaft unit 1 is firmly secured therein.

The axial textures 23 and radial textures 24 on the inner surface of the first combining section L21 have the effect of slide-proof. This is because when the transmission shaft unit 1 moves, the dust-proof cover 20 will not drive so that the design of the textures 23, 24 can firmly secure the dust-proof cover 20 to the transmission shaft unit 1. Thereby the textures have the effect of wear-proof.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A dust-proof cover made of rubber comprising:
an elastic telescopic section including a plurality of axial enhancing ribs;
a combining portion including a first combining section, a second combining section, and a third combining section; a width of the first combining section being greater than a width of the second combining section and the width of the second combining section being greater than the width of the third combining section; an inner wall and an outer wall of each first combining section; second combining section and third combining section being planes;
an inner side of each of the second combining section and third combining section having a respective first buckling strip; each first buckling strip having a chamfered corner for guiding the installation of the transmission shaft unit so as to enhance the coupling of the dust-proof cover and the transmission shaft unit;
two second buckling strips being formed on an inner surface of the first combining section; each second buckling strip having a respective chamfered corner for buckling an outer lateral side of the transmission shaft unit so as to buckle the transmission shaft unit; and
a plurality of axial textures being formed on the inner surface of the first combining section and a plurality of radial textures being formed on the inner surface of the first combining section.
